(19) United States
(12) Patent Application Publication
(10) Pub. No.: US 2014/0063708 A1
(43) Pub. Date: Mar. 6, 2014

(54) BUTTON CELL HOLDER

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: LEI LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/965,177

(22) Filed: Aug. 12, 2013

(30) Foreign Application Priority Data
Aug. 31, 2012 (CN) 201210317749X

(51) Int. Cl. G06F 1/18

(52) U.S. Cl. CPC G06F 1/188
USPC 361/679.02

(57) ABSTRACT

A button cell holder includes a main body and a button. The main body defines a receiving space to receive a button cell. The button cell supplies power for a basic input/output system (BIOS) chip. The button is electrically connected between the button cell and the BIOS chip. If the button is turned off for a predetermined period of time, data stored in the BIOS chip is erased.

### BACKGROUND

1. Technical Field

The present disclosure relates to a button cell holder.

2. Description of Related Art

A button cell is usually arranged on a motherboard of a computer to supply power to a basic input/output system (BIOS) chip, thereby maintaining data stored in the BIOS chip. If the BIOS chip malfunctions, the motherboard can use a jumper to clear data in the BIOS chip. However, an inexperienced user may not know how to use the jumper to clear the data stored in the BIOS chip.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is an isometric view of an embodiment of a button cell holder of the present disclosure.

FIG. 2 is similar to FIG. 1, but viewed from another perspective.

FIG. 3 is an assembled, isometric view of the button cell holder of FIG. 1, together with a motherboard and a button cell.

FIG. 4 is a circuit diagram of the coil cell holder of FIG. 1.

### DETAILED DESCRIPTION

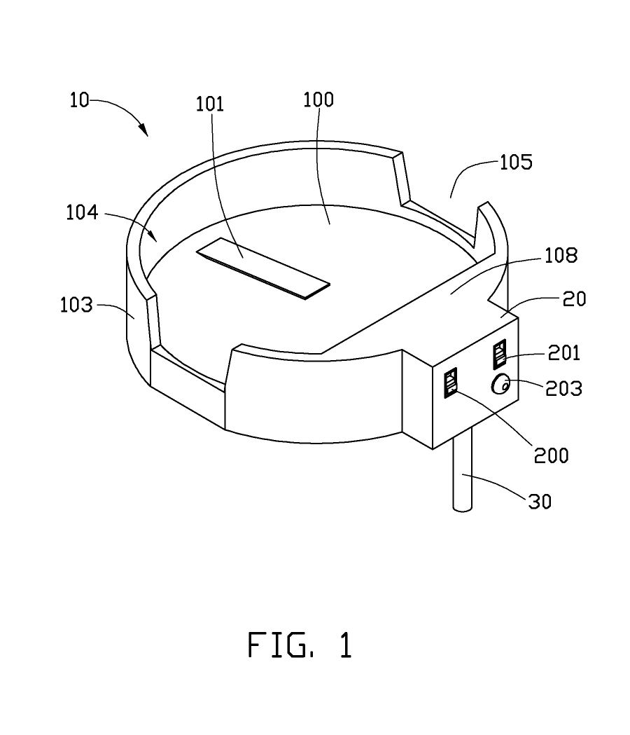

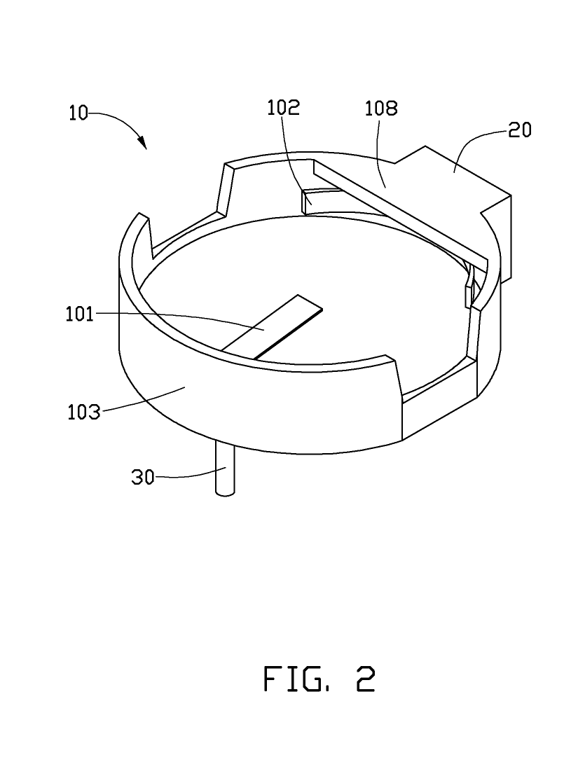

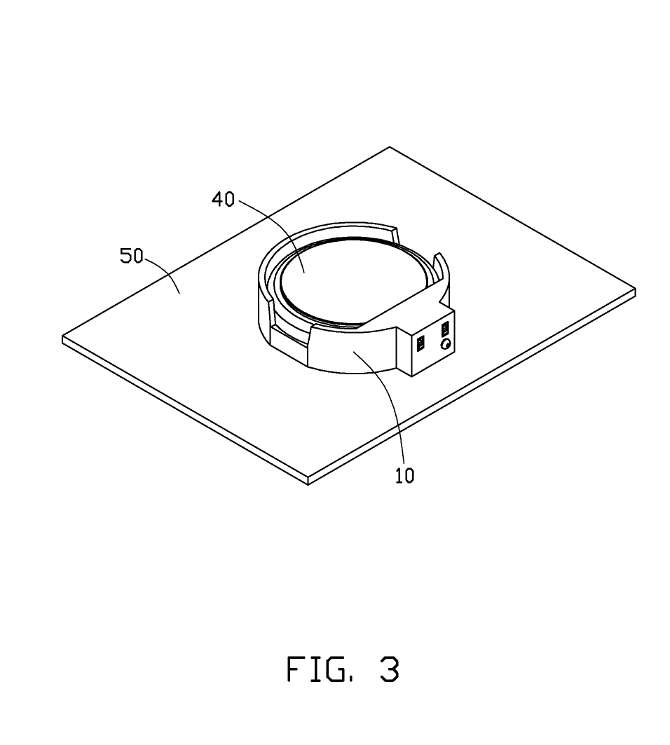

FIGS. 1 to 3 illustrate an embodiment of a button cell holder of the present disclosure. The button cell holder includes a main body 10, a first button 200, a second button 201, and a light-emitting diode (LED) 203.

The main body 10 receives a button cell 40, which supplies power for a basic input/output system (BIOS) chip 60 of a motherboard 50. The main body 10 includes a substantially round base 100. A plurality of pins 30 extends down from the base 100 to be soldered to the motherboard 50, so as to enable the main body 10 to be fixed on the motherboard 50. A circular sidewall 103 extends substantially perpendicularly up from a circumference of the base 100, thereby bounding a receiving space 104 with the base 100 to receive the button cell 40 therein. A first metal piece 101 is arranged on the base 100. A second metal piece 102 is attached on an inner surface of the sidewall 103. The first and second metal pieces 101 and 102 are used to connect to negative and positive terminals of the button cell 40, respectively. The sidewall 103 defines a plurality of cutouts 105, which help a user to easily grasp the button cell 40. A flange 20 protrudes from an outer surface of the sidewall 103. A stopper 108 extends inward from a top of the sidewall 103, so as to prevent the button cell 40 from disengaging from the receiving portion 104. The first button 200, the second button 201, and the LED 203 are arranged on a surface of the flange 20.

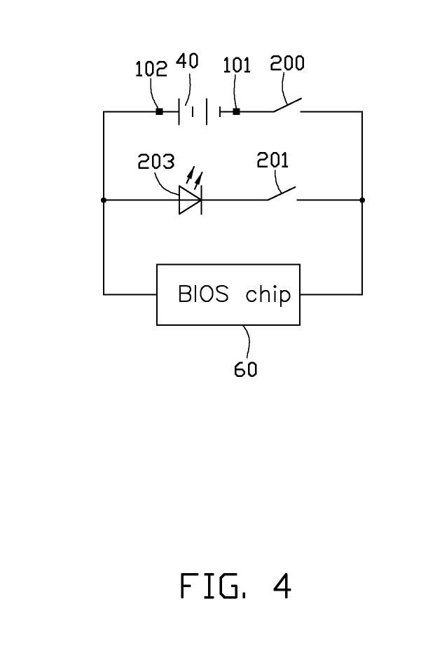

FIG. 4 shows that the first metal piece 101 is connected between the negative terminal of the button cell 40 and a first terminal of the first button 200. A second terminal of the first button 200 is connected to a first terminal of the second button 201. A second terminal of the second button 201 is connected to a cathode of the LED 203. An anode of the LED 203 is connected to the second metal piece 102. The second terminal of the first button 200 and the first terminal of the second button 201 are connected to the BIOS chip 60. The BIOS chip 60 is also connected to the second metal piece 102. When the button cell 40 is received in the receiving space 104, the positive terminal of the button cell 40 is electrically connected to the BIOS chip 60 through the second metal piece 102, and the negative terminal of the button cell 40 is electrically connected to the BIOS chip 60 through the first metal piece 101 and the first button 200, in that order. Accordingly, the BIOS chip 60 draws power from the button cell 40. In the embodiment, the LED 203 indicates a capacitance of the button cell 40. For example, if the LED 203 does not emit light, it means that the button cell 40 is out of power, thereby alerting a user to replace the button cell 40.

According to the working principle of the BIOS chip 60, when the button cell 40 supplies power to the BIOS chip 60, the first button 200 is turned on. Alternatively, when data in the BIOS chip 60 needs to be erased, the first button 200 is turned off for a predetermined period of time, and then is turned back on, thereby erasing the data in the BIOS chip 40.

While the disclosure has been described by way of example and in terms of preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A button cell holder, comprising:
a main body comprising a base, a sidewall extending up from the base, and a receiving space bounded by the base and sidewall for receiving a button cell;
a first metal piece mounted on a top of the base, to contact a negative terminal of the button cell;
a second metal piece mounted on an inner surface of the sidewall, to contact a positive terminal of the button cell, wherein the second metal piece is connected to a basic input output system (BIOS) chip; and
a first button comprising a first terminal connected to the first metal piece, and a second terminal connected to the BIOS chip.

2. The button cell holder of claim 1, wherein a plurality of cutouts is defined in the sidewall.

3. The button cell holder of claim 1, further comprising a light-emitting diode (LED) and a second button, wherein the second metal piece is connected to an anode of the LED, a cathode of the LED is connected to the second terminal of the first button through the second button.

4. The button cell holder of claim 3, wherein a flange is formed on an outer surface of the sidewall, the first button, the second button, and the LED are mounted on the flange.

5. The button cell holder of claim 4, wherein a plurality of pins extends down from the base.

6. The button cell holder of claim 5, wherein a stopper extends in from a top of the sidewall.
